(19) United States
(12) Patent Application Publication
(10) Pub. No.: US 2007/0164706 A1
(43) Pub. Date: Jul. 19, 2007

(54) Controller built in electrical tool powered by Li-battery

(75) Inventor: Chen-Ku Wei, Nantou County (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO., LTD., TAICHUNG HSIEN (TW)

(21) Appl. No.: 11/332,348

(22) Filed: Jan. 17, 2006

(51) Int. Cl. H02J 7/00

(52) U.S. Cl. 320/130

(57) ABSTRACT

A controller built in Li-battery electric tool includes a microprocessor, a charging switch loop, a battery voltage detecting loop, a motor driving loop, and a power circuit. The charging switch loop is connected with the microprocessor and connected to a chargeable battery and a charging source, for controlling the charging status of the rechargeable battery. The battery voltage detecting loop is connected with the microprocessor for detecting the voltage of the rechargeable battery. The motor driving loop is connected with the microprocessor, having an electrically-controlled switch connected with a motor mounted inside the electric tool. The power circuit is connected with the microprocessor and the charging source, for providing the microprocessor with a power source. Thus, the rechargeable battery can be controlled while charged and discharged, and the present invention is of few components and small-sized as advantages.

### BACKGROUND OF THE INVENTION

1. Field of the Invention

The present invention relates generally to control technology for battery-based electric tools, and more particularly, to a controller built in am electric tool powered by a Li-battery.

2. Description of the Related Art

A conventional hand-held electric tool is usually powered by the Ni—Cd battery. However, such Ni—Cd battery is gradually replaced by Li-battery because of its heavy weight and large size. Since the Li-battery is lightweight, of great energy intensity, small-sized, and of little leakage current, the Li-battery has become more and more popular for use in electric tools. The difference between the Li-battery and the Ni—Cd battery lies in that the Li-battery is less safe than the Ni—Cd battery to require more functions and protections, the electric tool must have a control panel for execution of control of charging and motor operation. Because the voltage of the Li-battery drops down to a very low voltage, e.g. lower than 2.6V, while the Li-battery is discharged, the control panel should be able to work under low-voltage environment to be applicable, and thus the control panel is generally of linear-circuit layout. However, the linear circuit is of excessive components, high-cost, of excessive parameters, difficult in manufacturing and processing, and of limited functions covered thereby. If the control panel is of application specific integrated circuit (ASIC) layout, the development cost will be high and the application of the layout is insufficiently flexible.

As shown in FIG. 3, a conventional control panel 70 of linear-circuit layout includes a charging system 71 and a motor-driving system 76. The charging system 71 has a charging loop 72 and a control circuit 73. The charging loop 72 is composed of a resistor R2, a transistor Q1, and a diode D2. The control circuit 73 is composed of a Zener diode ZD1 and a power semiconductor Q2, such as silicon-controlled rectifier (SCR). The motor-driving system 76 primarily has a microprocessor 77, a power semiconductor Q4 (SCR), and two Schottky diodes D5 and D6.

In the conventional control panel 70 as shown in FIG. 3, because the charging system 71 has the power semiconductor Q3 (SCR), and to prevent the charging system from erroneous triggering, a resistor-capacitor (RC) circuit (C5 and R4) having a huge RC constant is usually required to stabilize any surge. However, there are some disadvantages recited below. Because the breakdown current Iz of the Zener diode ZD1 is very small and at non-saturated status, it is difficult to set up an accurate value of full-charge voltage while the variance of the breakdown voltage Vz is great. The value of full-charge voltage is also vulnerable to great variance of temperature. Furthermore, the capacity of the capacitor C5 has to be very large to prevent any voltage surge from erroneously triggering the power semiconductor element Q2 (SCR), but the capacitor of large capacity is relatively large-sized such that the control panel 70 fails to diminish its size. The variance of triggering current Igt of the power semiconductor element Q2 also makes it more complicated and difficult to set up the full-charge voltage.

In addition, the motor driving system 76 of the control panel 70 employs a reset IC (BD4727G) to enable low leakage current of the battery. To prevent the battery from overdischarge, while the battery voltage drops down to a predetermined voltage, the discharging loop has to be disabled such that the power semiconductor element Q4 is acted as a driving element, however increasing the IC cost, enlarging the size, and erroneous triggering of the power semiconductor element Q4. After the battery is used for a while, the battery voltage is lower than 3.0V. To avoid the leakage current, while a trigger switch S1 is ON, the current of power source flows into the circuit through a diode D6 or D5. The voltage of 3.0V passes through the diode D5 or D6 to drop down to 2.5V, and meanwhile, it is insufficient to drive a gate terminal G of a metal-oxide-semiconductor field-effect transistor (MOSFET) Q5, because it is lower than the starting voltage Vgs of the gate terminal G, to disable the MOSFET Q5, thus shortening the working time of the tool. Moreover, the diode D5 or D6 made of Schottky diode is high-cost, and while the starting voltage Vgs of the gate terminal G of the MOSFET Q5 directly enters from the motor power, high-voltage noises generated by the motor operation penetrates through the gate terminal Q and thus a capacitor C7 is required for protection of the gate terminal G However, it increases the number of the elements as well.

### SUMMARY OF THE INVENTION

The primary objective of the present invention is to provide a controller built in Li-battery electric tool that can improve the defects of the conventional control panel.

The secondary objective of the present invention is to provide a controller built in Li-battery electric tool that protects itself against abnormalities of temperature and motor current in addition to controls of charging and motor driving.

The foregoing objectives of the present invention are attained by the controller built in Li-battery electric tool includes a microprocessor, a charging switch loop, a battery voltage detecting loop, a motor driving loop, and a power circuit. The charging switch loop is connected with the microprocessor and connected to a chargeable battery and a charging source, for controlling the charging status of the rechargeable battery. The battery voltage detecting loop is connected with the microprocessor for detecting the voltage of the rechargeable battery. The motor driving loop is connected with the microprocessor, having an electrically-controlled switch connected with a motor mounted inside the electric tool. The power circuit is connected with the microprocessor and the charging source, for providing the microprocessor with a power source. Thus, the rechargeable battery can be controlled while charged and discharged, and the present invention is of few components and small-sized as advantages.

### BRIEF DESCRIPTION OF THE DRAWINGS

FIG. 1 is a block diagram of a preferred embodiment of the present invention.

FIG. 2 shows a circuitry of the preferred embodiment of the present invention.

FIG. 3 shows a circuitry of a conventional panel.

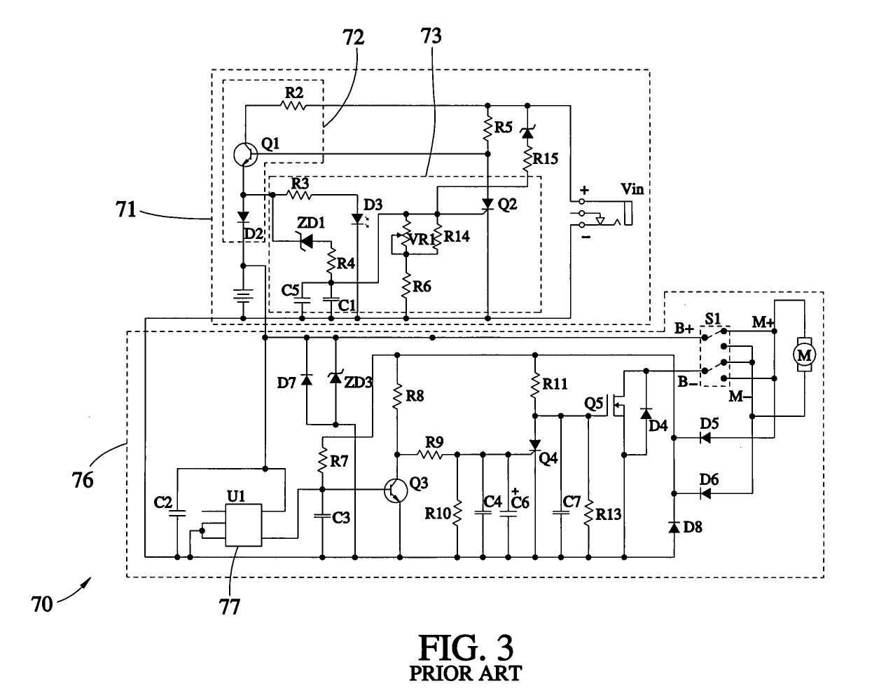

### DETAILED DESCRIPTION OF PREFERRED EMBODIMENTS

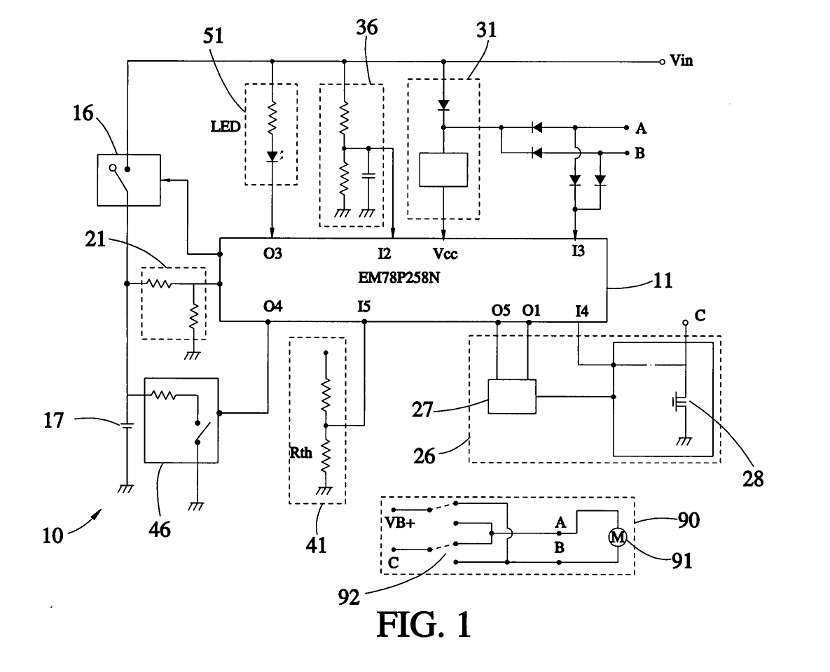

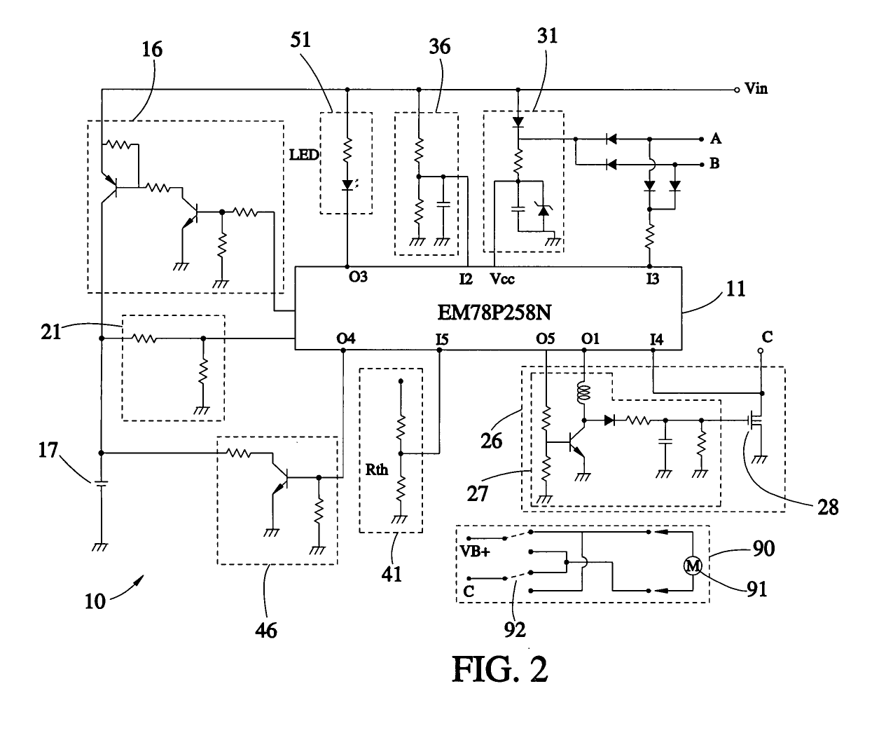

Referring to FIGS. 1 and 2, a controller 10 built in a Li-battery electric tool constructed according to preferred embodiment of the present invention is connected with a switch-triggering loop 90 of an electric tool (not shown). The controller 10 is composed of a microprocessor 11, a charging switch loop 16, a battery voltage detecting loop 21, a motor driving loop 26, a power circuit 31, a charging power voltage detecting loop 36, a battery temperature detecting loop 41, a discharging loop 46, and a display loop 51.

The microprocessor 11, which model number is EM78P258N, includes an output-control motor pin O1, an output power pin O5, a switch input pin 13, and a voltage-drop detecting pin 14, for computation and signal output/input.

The charging switch loop 16 is connected with the microprocessor 11 and connected to a rechargeable battery and a charging source Vin, for controlling the charging status of the rechargeable battery 17.

The battery voltage detecting loop 21 is connected with the microprocessor 11, for detecting the voltage of the rechargeable battery 17.

The motor driving loop 26 includes a charge pumping loop 27 and an electrically-controlled switch 28. The charge pumping loop 27 is connected with the microprocessor 11, for enhancing voltage. The electrically-controlled switch 28 is connected to a motor 91 connected with the switch-triggering loop 90. The electrically-controlled switch 28 is also connected to the voltage-drop detecting pin 14 for detecting the voltage of the electrically-controlled switch 28 by the microprocessor 11. The electrically-controlled switch 28 is an MOSFET in this embodiment.

The power circuit 31 is connected with the microprocessor 11 and the charging source Vin, for providing said microprocessor 11 with required power source. The power circuit 31 is also connected with a power source (not shown) connected with a switch 92 of the switch-triggering loop 90.

The charging power voltage detecting loop 36 is connected with the microprocessor 11 and the charging source Vin, for detecting the voltage of the charging source Vin.

The battery temperature detecting loop 41 includes a thermal-sensitive resistor Rth connected with the microprocessor 11 and attached to the rechargeable battery 17.

The discharging loop 46 is connected with the microprocessor 11 and the rechargeable battery 17, for control of partial discharge of the rechargeable battery 17 during its charging process.

The display loop 51 includes a light-emitting diode (LED) connected with the microprocessor 11.

While operated, the present invention employs the microprocessor 11 for controls. The charging switch loop 16 controls whether the rechargeable battery 17 is charged or not by the charging current via the microprocessor 11. If the voltage of the rechargeable battery 17 does not reach a default value, the rechargeable battery 17 will be charged until its voltage reaches the default value. After the voltage of the rechargeable battery 17 reaches the default value, the charging switch loop 16 is closed and lock-on. Unless the charging source Vin is unplugged and then plugged in again, the charging switch loop 16 is not reset. The battery voltage detecting loop 21 is to directly detect the voltage of the rechargeable battery 17. The charging power voltage detecting loop 36 is to detect the voltage of the charging source Vin to prevent the circuits from burnout incurred by erroneous connection with adaptors.

In addition, the motor driving loop 26 is controlled by the microprocessor 11 which the output-control motor pin O1 cooperates with the output power O5 for output of pulse width modulation (PWM) and cooperates with the charge pumping loop 27 for enhancement of the voltage, and thus the voltage Vgs of the gate terminal G of the electrically-controlled switch 28 can be easily enhanced, such that while the voltage of the rechargeable battery 17 is relatively low, it is still successful to enable the electrically-controlled switch 28 to drive the motor 91. The power circuit 31 can be either the charging source Vin or the power source (not shown) connected with the switch 92 of the switch-triggering loop 90. While the switch 92 is conducted, a delay is generated by that the microprocessor 11 receives a signal via the switch input pin 13 and then controls the electrically-controlled switch 28 for conduction. Such delay enables that butting points of the switch 92 are closely contacted before the motor 91 starts, thus eliminating noises generated by the switch 92 bouncing under heavy current and then further preventing the noises from adverse influence on the whole circuitry.

Furthermore, the discharging loop 46 discharges the battery 17 under a predetermined status and provides convenient control for temporal discharge required during the charging operations. The microprocessor 11 employs an LED-control pin O3 to control the LED of the display loop 51 for illumination and display. The voltage-drop detecting pin 14 is to detect the voltage drop of the electrically-controlled switch 28. While the motor 91 is short-circuit (overloaded) or stopped, the current is amplified and the voltage drop of the electrically-controlled switch 28 is increased linearly to be detected. Thus, the voltage-drop detecting pin 14 can protect against the abnormality of the current, further reducing the consumption of the power and enhancing the operating range. Finally, the power temperature detecting loop 41 employs the thermal-sensitive resistor Rth attached to the rechargeable battery 17 to effectively detect the temperature of the battery 17 and then to enable the microprocessor 11 to stop charging or to discharge, thus protecting the battery 17.

As indicated above, the present invention improves the defects of the conventional control panel for protection of the rechargeable battery 17 and various controls, such as control of charging switch of the battery, control of charging voltage, use of the battery having low voltage, and protection against overcurrent and temperature rise. Moreover, the circuitry of the present invention having less components and being smaller than the prior art.

Although the present invention has been described with respect to a specific preferred embodiment thereof, it is no way limited to the details of the illustrated structures but changes and modifications may be made within the scope of the appended claims.

What is claimed is:

1. A controller built in a Li-battery electric tool, comprising:
a microprocessor;
a charging switch loop connected with said microprocessor and with a rechargeable battery and a charging source, for controlling a charging status of said rechargeable battery;
a battery voltage detecting loop connected with said microprocessor for detecting a voltage of said rechargeable battery;
a motor driving loop connected said microprocessor, said motor driving loop having an electrically-controlled switch connected with a motor mounted inside said electric tool; and
a power circuit connected with said microprocessor and said charging source for providing said microprocessor with a power source.

2. The controller as defined in claim 1 further comprising a charging power voltage detecting loop, said charging power voltage detecting loop being connected with said microprocessor and said charging source.

3. The controller as defined in claim 1, wherein said power circuit is connected with said microprocessor and a power source connected with a switch of said electric tool.

4. The controller as defined in claim 1, wherein said electrically-controlled switch is a metal-oxide-semiconductor field-effect transistor (MOSFET).

5. The controller as defined in claim 4, wherein said microprocessor includes a voltage-drop detecting pin connected with said electrically-controlled switch for detecting a voltage of said electrically-controlled switch.

6. The controller as defined in claim 1 further comprising a battery temperature detecting loop, wherein said battery temperature detecting loop includes a thermal-sensitive resistor connected with said microprocessor and attached to said rechargeable battery.

7. The controller as defined in claim 1, wherein said motor driving loop includes a charge pumping loop.

8. The controller as defined in claim 1 further comprising a discharging loop, wherein said discharging loop is connected with said microprocessor and said rechargeable battery for controlling discharge of said battery.

9. The controller as defined in claim 1 further comprising a display loop, wherein said display loop includes a light-emitting diode (LED) connected with said microprocessor.
